(19) United States
(12) Patent Application Publication
(10) Pub. No.: US 2025/0021667 A1
(43) Pub. Date: Jan. 16, 2025

(54) SECURE MULTI-ENDPOINT CIPHER NEGOTIATION

(71) Applicant: VMware LLC, Palo Alto, CA (US)

(72) Inventors: Daniel James BEVERIDGE, Valrico, FL (US); David OTT, Chandler, AZ (US); Sean HUNTLEY, NSW (AU); Martin Patrick STACK, Folsom, CA (US)

(21) Appl. No.: 18/351,538

(22) Filed: Jul. 13, 2023

(51) Int. Cl. G06F 21/60; H04L 9/00

(52) U.S. Cl. CPC G06F 21/602; H04L 9/008

(57) ABSTRACT

The disclosure provides an approach for multi-endpoint cipher negotiation. Embodiments include determining, by one or more first endpoints of a plurality of endpoints involved in a multi-party data aggregation process, a privacy-preserving version of an underlying function to be evaluated for cryptographic technique selection. Embodiments include sending, by the one or more first endpoints, to a second endpoint of the plurality of endpoints, the privacy-preserving version of the underlying function and encrypted input values related to attributes of the one or more first endpoints. Embodiments include evaluating, by the second endpoint, the privacy-preserving version of the function based on the encrypted input values and one or more additional encrypted input values. Embodiments include determining, based on the evaluating of the privacy-preserving version of the function, one or more cryptographic techniques to be used for the multi-party data aggregation process.

### BACKGROUND

Cryptography generally involves techniques for protecting data from unauthorized access. For example, data transmitted over a network may be encrypted in order to protect the data from being accessed by unauthorized parties. For example, even if the encrypted data is obtained by an unauthorized party, if the unauthorized party cannot decrypt the encrypted data, then the unauthorized party cannot access the underlying data. There are many types of cryptographic algorithms, and these algorithms vary in many aspects such as key size, ciphertext size, memory requirements, computation requirements, amenability to hardware acceleration, failure handling, entropy requirements, and the like. Key size refers to the number of bits in a key used by a cryptographic algorithm. Key size affects the strength of a cryptographic technique and is a configuration parameter. Having more bits in a key size results in more computation, but a larger space of possible mappings from cleartext to ciphertext, which is a quality makes it harder for an adversary to guess a key having a larger number of bits.

Ciphertext size refers to the number of bits in the output from a cryptographic algorithm, which may be the same as the number of bits of the input or may include padding to produce a larger number of bits than the input. Memory requirements and computation requirements generally refer to the amount of memory and processing resources required to perform an algorithm. Amenability to hardware acceleration generally refers to whether an algorithm requires or can be improved through the use of a hardware accelerator. For example, a compute accelerator is an additional hardware or software processing component that processes data faster than a central processing unit (CPU) of the computer. Failure handling refers to the processes by which an algorithm accounts for failures, such as recovering keys that are lost or deactivated. Entropy requirements generally refer to the amount of randomness required by an algorithm, such as an extent to which randomly generated values are used as part of the algorithm (e.g., which generally improves security of the algorithm).

Data aggregation generally involves receiving multiple items of data, such as from different data sources, and performing one or more computations in order to produce an aggregated result based on the multiple items of data. One example of data aggregation is federated learning, which generally refers to techniques in which an algorithm is trained across multiple decentralized edge devices or servers that hold local data without exchanging the local data between the edge devices. In one example, edge devices perform local training and provide training results to an aggregator device, which aggregates the training results among the multiple edge devices to update a centralized model, which can then be re-distributed to the edge devices for subsequent training and/or use. Cryptography may be used in a data aggregation process (e.g., federated learning) in order to protect data during transmission, such as between edge devices and an aggregator device. For example, edge devices may encrypt local data before sending it to the aggregator device, such as sharing an encryption key with the aggregator device via a separate secure channel, and the aggregator device may encrypt a final result of aggregation (e.g., a centralized model) in a similar manner before sending it back to the edge devices.

While existing data aggregation techniques may protect data during transmission between endpoints, these techniques require the endpoints to be trusted with access to the unencrypted data. For example, an aggregator device must be trusted to access the local data from all participating edge devices. Furthermore, existing data aggregation techniques rely on fixed cryptographic techniques, such as those that the software applications performing the operations related to data aggregation are configured to support, and these fixed cryptographic techniques may not be optimal for the varying contexts in which data aggregation techniques are performed.

Furthermore, existing techniques generally involve each endpoint in a multi-endpoint aggregation process selecting cryptographic techniques independently or in concert based on publicly shared preferences and/or other attributes, such as through a cipher negotiation process. However, existing techniques for negotiation of ciphers require endpoints to share preferences and/or other attributes with one another. In some cases, preferences and other attributes related to selection of cryptographic techniques may include sensitive information, and existing cipher negotiation processes require sharing such sensitive information between endpoints.

As such, there is a need for improved techniques for secure and performant data aggregation, including improved techniques for negotiation of cryptographic techniques between multiple endpoints.

### BRIEF DESCRIPTION OF THE DRAWINGS

FIG. 1 is an illustration of example computing components related to secure multi-endpoint cipher negotiation, according to embodiments of the present disclosure.

FIG. 2 is an illustration of an example related to dynamic cryptographic technique selection, involving secure multi-endpoint cipher negotiation, for privacy-preserving data aggregation.

FIG. 3 is an illustration of an example related to secure multi-endpoint cipher negotiation.

FIG. 4 depicts an example of tagging cryptographic techniques based on parameters related to privacy-preserving data aggregation for use in secure multi-endpoint cipher negotiation.

FIG. 5 depicts example operations for secure multi-endpoint cipher negotiation, according to embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure relates to cryptographic agility for privacy-preserving data aggregation. In particular, the present disclosure provides an approach for dynamically selecting cryptographic techniques, such as homomorphic encryption techniques, through an improved secure multi-endpoint negotiation process based on parameters related to a privacy-preserving data aggregation process. In certain embodiments, secure multiparty computation techniques are used to negotiate a cryptographic technique selection process among multiple endpoints in a manner that preserves the privacy of attributes of the individual endpoints that are used in the negotiation process.

Cryptographic agility generally refers to techniques for dynamic selection and/or configuration of cryptographic algorithms, including through secure multi-endpoint cipher negotiation. According to certain embodiments, logic related to selection and/or configuration of cryptographic algorithms is decoupled from the applications that utilize cryptographic functionality, and is implemented in one or more separate components. Thus, rather than an application directly calling a cryptographic library to perform cryptographic functionality, the application may call generic cryptographic functions provided by a separate cryptographic agility system, and the cryptographic agility system may then select and/or configure cryptographic algorithms, such as based on contextual information and/or policies and, in some embodiments, based on a privacy-preserving cipher negotiation process with one or more other endpoints. For instance, the cryptographic agility system may dynamically determine which libraries, algorithms, configuration values, and/or the like to select based on factors such as the type of data being encrypted, the type of application requesting encryption, the network environment(s) in which the data is to be sent, a destination to which encrypted data is to be sent, geographic locations associated with a source and/or destination of the data, attributes of users associated with the encryption, regulatory environments related to the encryption, network conditions, resource availability, performance constraints, device capabilities, and/or the like. For example, the selection process may be based on attributes related to multiple devices involved in a privacy-preserving data aggregation process, such as devices from which data is sent to one or more aggregator devices as well as the one or more aggregator devices themselves.

According to embodiments of the present disclosure, cryptographic techniques are dynamically selected based on attributes related to a privacy-preserving data aggregation process (e.g., a federated learning process), such as whether an aggregator device is trusted to access the data being aggregated, whether the aggregator device has one or more types of hardware required for confidential computing, hardware/resource constraints of the devices involved in the process, based on the mathematical operations to be performed by an aggregator device in order to produce an aggregated result (e.g., in the case of homomorphic encryption), and/or the like. In a particular example, different types of confidential computing techniques and/or homomorphic encryption algorithms may be dynamically selected for privacy-preserving data aggregation based on a variety of factors. For example, while many cryptographic techniques involve encrypting data at the source and decrypting the data at the destination in order to protect the privacy of the data during transmission, homomorphic encryption techniques and confidential computing techniques provide an additional benefit of preserving the privacy of the data while it is processed at the destination, thereby allowing for arrangements in which the data is never decrypted at the destination.

Confidential computing generally refers to computing techniques that isolate sensitive data in a protected processor enclave during processing. The enclave may be referred to as a trusted execution environment (TEE). The contents of the enclave, including the data that is processed and the logic used to process the data, are accessible only to authorized programming code, and are invisible and in accessible to any other components outside of the enclave. Such an enclave or TEE may be an example of a confidential computing component as discussed herein. Confidential computing provides many advantages, such as the ability to perform computations on sensitive data without exposing the sensitive data to any entities outside of the secure enclave, including not exposing the sensitive data to any other components of the device on which the secure enclave is located and/or to an entity that operates such a device (e.g., a cloud provider). Furthermore, confidential computing is generally resource-efficient with respect to processor, memory, and network resources. However, confidential computing requires specialized hardware (e.g., a secure processor enclave), and so cannot be performed in the absence of such hardware.

Homomorphic encryption generally refers to encryption techniques that allow one or more types of mathematical operations to be performed on encrypted data without decryption and without exposing the underlying data. With homomorphic encryption, the result of performing a mathematical operation on the encrypted data remains in an encrypted form that, when decrypted, results in an output that is identical to that produced had the mathematical operation been performed on the unencrypted data. While an aggregator device could otherwise learn about a private data set from parameter information that is sent as part of a data aggregation process, certain embodiments of the present disclosure prevent such disclosure of private information through the use of dynamically-selected homomorphic encryption techniques. Homomorphic encryption techniques can be resource-intensive with respect to processor, memory, and network resources, but do not generally require specialized hardware.

According to techniques described herein, selecting a homomorphic encryption technique for use in a secure aggregation process allows an aggregator device to perform computations on encrypted data received from multiple endpoints (e.g., edge devices) without the aggregator device being granted access to the unencrypted data, and thereby preserving the privacy of the underlying data, while producing an aggregated result that can be decrypted by the endpoints as if the computations had been performed on the unencrypted data. For example, if local models at multiple edge devices are being trained based on local data that is sensitive and yet there is a desire to train a global model that is not biased by the potentially unique attributes of the local data, the edge devices may encrypt their local model parameters (e.g., gradients) using homomorphic encryption and then send the encrypted local model parameters to the aggregator device for aggregation in a privacy-preserving manner. The aggregator device may perform computations on the encrypted local model parameters received from the edge devices in order to determine global model parameters (which will remain encrypted). The global model parameters, when sent back to the edge devices, can be decrypted using the same homomorphic encryption key or keys used to encrypt the local model parameters in order to produce an unencrypted global model at the edge devices.

There are different types of homomorphic encryption algorithms that support different types of mathematical operations. For example, some homomorphic encryption algorithms only allow addition to be performed on the encrypted data, some homomorphic encryption algorithms allow multiplication to be performed on the encrypted data, and some homomorphic algorithms are “fully homomorphic” such that they support the full range of possible mathematical operations on the encrypted data. Generally, a fully homomorphic encryption algorithm allows the evaluation of arbitrary circuits composed of multiple types of gates of unbounded depth and is the strongest notion of homomorphic encryption. Furthermore, there are many different types of fully homomorphic encryption techniques and many different types of partially homomorphic encryption techniques, including many different potential configurations of many different potential algorithms associated with many different potential libraries, and selection among these different techniques may be based on a variety of factors, such as the mathematical operations to be performed, the resource-efficiency of these techniques, the level of security of these techniques, attacks protected against, device limitations, and/or the like.

Different homomorphic encryption algorithms have different levels of security and/or vary in the amount of computing resources (e.g., processing, memory, and/or network resources) that are utilized during encryption, decryption, and transmission of encrypted data. For example, fully homomorphic encryption algorithms are generally resource-intensive, and so cannot be used on devices with limited available computing resources.

Thus, according to embodiments of the present disclosure, different types of privacy-preserving cryptographic techniques, including homomorphic encryption techniques and/or confidential computing techniques, may be dynamically selected for different situations based on, for example, the resource constraints and capabilities of one or more devices from which data is aggregated, the resource constraints and capabilities of one or more aggregator devices, which mathematical operations are to be performed by the one or more aggregator devices, required level(s) of security with respect to the involved devices, and/or the like.

In certain embodiments different cryptographic techniques may be selected for different devices involved in a single data aggregation process based on factors that differ between the devices. For example, different devices may have differing resource constraints and capabilities, differing security requirements (e.g., based on locations or organizations with which the devices are associated), may perform differing mathematical operations (e.g., if multiple layers of aggregation are involved and different operations are performed at different layers), and/or the like. Thus, some embodiments may involve securely translating between cryptographic techniques in a privacy-preserving manner, such as through the use of a confidential computing environment.

According to techniques described herein, multiple endpoints involved in a data aggregation process perform a privacy-preserving cipher negotiation process in order to select one or more cryptographic techniques for use in the data aggregation process. For example, a cryptographic server associated with each endpoint may provide cryptographic technique selection as a service, such as allowing endpoints to request privacy-preserving cryptographic operations via one or more application programming interface (API) calls, and the cryptographic servers associated with the endpoints may negotiate with one another to select one or more cryptographic techniques that comply with preferences, constraints, and other attributes related to the involved devices and the data aggregation process.

In one example, local models at multiple edge devices are being trained based on local data that is sensitive (e.g., medical information, personally identifiable information (PII), classified information, private user data, and/or the like) and yet there is a desire to train a global model that is not biased by the potentially unique attributes of the local data. One or more of the edge devices may initiate a cryptographic technique selection process, such as by communicating with an associated cryptographic server (e.g., via an API), and the cryptographic servers associated with the edge devices may engage in a privacy-preserving cipher negotiation process. According to certain embodiments, a secure multiparty computation technique is used to perform the cipher negotiation.

Secure multiparty computation is a problem in which N distrustful parties P₁, . . . , P_{N} hold private inputs x₁, . . . , x_{N} and want to compute some function ƒ(·) on these inputs without revealing anything about the inputs except the output of the function. For example, users of one or more computing devices may wish to make a shared determination (e.g., regarding which cryptographic technique to utilize) based on sensitive data (e.g., local preferences and other parameters) without allowing one another to access the sensitive data.

### Overview of Garbling Techniques

One example solution for secure multiparty computation is ‘garbling’. Given parties P₁ and P₂ with inputs x₁ and x₂ respectively, P₁ may be considered the ‘garbler’ and P₂ may be considered the ‘evaluator’. At a high level, the garbler takes the function ƒ and constructs a new function ƒ′ that preserves the functionality of ƒ but also preserves the privacy of the inputs. Then, the garbler transforms its input x₁ into a ‘garbled’ input x′₁ and also helps the evaluator to transform its input x₂ into a ‘garbled’ input x′₂. The garbler sends ƒ′ and x′₁ to the evaluator, which already has x′₂. Finally, the evaluator evaluates ƒ′ (x′₁, x′₂) to obtain the output y. When both parties are honest it is guaranteed that ƒ′ (x′₁,x′₂)=ƒ(x₁, x₂). It is also guaranteed that the parties do not learn anything that they do not initially know about x₁ or x₂ beyond the output ƒ(x₁, x₂).

Generally, ƒ is a Boolean circuit that may include AND (∧) and XOR (∨) logical gates. For a, b∈{0, 1} it is known that ∧(a, b)=1 iff (if and only if) a=b=1 and that ∧(a, b)=0 otherwise. Similarly it is known that ∨(a, b)=0 iff a=b=0 and ∨(a, b)=1 otherwise.

An example of a garbling scheme is Yao's garbled circuit, introduced by Andrew Yao in 1986. In Yao's garbled circuit, the garbler picks two random strings, also called labels, for every wire in the circuit. For the j-th wire, its random labels are denoted by K^{j}₀ and K^{j}₁, which represent the bits 0 and 1, respectively. On their own, K^{j}₀ and K^{j}₁ look the same, as both are random strings. Only the garbler knows that K^{j}₀ represents 0 and K^{j}₁ represents 1.

For gate g in the circuit, g(·) represents the function of the gate. The input wires of g are a and b and the output wire of g is c. In Yao's garbling algorithm, the garbler computes the following four ciphertexts ct₀₀, ct₀₁, ct₁₀, ct₁₁:

$$c {t}_{00} = Enc ( {K}_{0}^{a} , Enc ( {K}_{0}^{b} , {K}_{g ( 0 , 0 )}^{c} ) )$$

$$c {t}_{01} = Enc ( {K}_{0}^{a} , Enc ( {K}_{1}^{b} , {K}_{g ( 0 , 1 )}^{c} ) )$$

$$c {t}_{10} = Enc ( {K}_{1}^{a} , Enc ( {K}_{0}^{b} , {K}_{g ( 1 , 0 )}^{c} ) )$$

$$c {t}_{11} = Enc ( {K}_{1}^{a} , Enc ( {K}_{1}^{b} , {K}_{g ( 1 , 1 )}^{c} ) )$$

“Enc” represents an encryption function. For example, if g=∧ then ct₀₀ is an encryption of K^{c}₀ using keys K^{a}₀ and K^{b}₀. The garbler sets the garbled gate g′ to be the values {ct₀₀, ct₀₁, ct₁₀, ct₁₁} in a random order. For each gate g, the garbler sends the garbled gate g′ to the evaluator. For every circuit-output wire j, the garbler sends the map mapⱼ={K^{j}₀=0, K^{j}₁=1} to the evaluator.

For every input wire j, the evaluator obtains one label (either K^{j}₀ or K^{j}₁, but not both). Specifically, xⱼ is the private input to that wire j (known by either the garbler or the evaluator), and the evaluator obtains the label K^{j}ₓⱼ. The evaluator may obtain this label in a variety of ways known in the art (without the garbler knowing what the evaluator obtained).

The evaluator evaluates the garbled circuit in a gate by gate fashion. It begins by having a single label (used as a key) for each input wire. The key for wire j is K^{j} (it is noted that the evaluator does not necessarily know whether K^{j}=K^{j}₀ or K^{j}=K^{j}₁). For each gate g (in a topological order), a, b are its input wires and c is its output wire. Furthermore, g′={ct₁, ct₂, ct₃, ct₄} is the garbled gate given to the evaluator. The evaluator attempts to decrypt the ciphertexts one by one, until the decryption succeeds (it is guaranteed, with high probability, to succeed in exactly one of the attempts). If the decryption succeeds for ctᵢ, then the evaluator sets K^{c}=Dec(K^{a}, Dec(K^{b}, ctᵢ)). “Dec” represents a decryption function.

For each circuit-output wire j, the evaluator computes the bit yⱼ=map(K^{j}). Finally, the evaluator outputs the evaluation y=(yⱼ₁, . . . , yⱼₘ), where j1, . . . , jm are the indices of the output wires of the circuit.

Garbling can be used for multiparty computation. Specifically, N parties can collaboratively take the role of the garbler and compute the garbling procedures described above to generate and output the garbled circuit (the collection of garbled gates). In addition, the N parties can collaboratively output a single key per input wire, and every party can take the role of the evaluator on its own and obtain the evaluation of the circuit.

Garbling techniques can be performed using a different N-party multiparty computation protocol that involves picking two random labels per wire and then computing the garbled gates as described above. For example, such a protocol may output a single label per input wire and the map associated with each output wire. These actions may be performed without any of the parties knowing the private inputs of the other parties. Finally, given a single label per input wire, all garbled gates, and the maps for the output wires, each party can take the role of the evaluator and obtain the output of the circuit on the private inputs.

The garbling techniques described above are included as examples of secure multiparty computation techniques, and other techniques may also be used in embodiments of the present disclosure. One example of a secure computation technique is described in U.S. patent application Ser. No. 17/807,758, the contents of which are incorporated herein by reference in their entirety.

In an example implementation, one or more first endpoints (e.g., edge devices) in a multi-endpoint data aggregation process take on the role of the garbler, and generate an encrypted version of a function to be evaluated, such as a function that accepts endpoint parameters as inputs and computes an output related to selecting a cryptographic technique. In one example, the input parameters include resource constraints, device capabilities, geographic location, user and/or organization preferences (e.g., preferences for homomorphic encryption rather than confidential computing or vice versa, preferences for prioritizing security over efficiency or vice versa, required levels of security, and/or the like), types and/or numbers of mathematical operations to be performed by one or more aggregator devices, an indication of whether one or more aggregator devices have certain hardware components (e.g., a secure enclave), an indication of whether one or more aggregator devices are trusted to access unencrypted data, and/or the like. An output of the function may be, for example, one or more specific cryptographic techniques that satisfy the input parameters, one or more types or classes of cryptographic techniques that satisfy the input parameters, and/or one or more data points that can be used to select one or more cryptographic techniques, such as a minimum level of security that satisfies the input parameters, a maximum amount of utilization of various types of resources that is permitted by the input parameters, whether confidential computing can be used, whether certain types of homomorphic encryption algorithms can be used, and/or the like.

The encrypted version of the function is designed such that an output of the encrypted function in response to encrypted input parameters is equal to an output of the underlying function in response to the unencrypted input parameters. The one or more first endpoints also generate encrypted versions of their own local input parameters according to the garbling technique.

A second endpoint (e.g., edge device) takes on the role of the evaluator in the garbling process. At least one of the one or more first endpoints provide information to the second endpoint that allows the second endpoint to generate an encrypted version of its own local input parameters. For example, the information may be an encryption key or mapping information that allows the second endpoint to encrypt its own local input parameters while not allowing the second endpoint to decrypt the function or the encrypted input parameters from the other endpoints, such as using techniques known in the art of secure computation. The second endpoint uses the received information to encrypt its local input parameters.

The one or more first endpoints provide the encrypted version of the function and their own local encrypted input parameters to the second endpoint. The second endpoint then evaluates the encrypted version of the function by providing the received encrypted input parameters and the second endpoint's own local encrypted input parameters as inputs to the encrypted version of the function. The second endpoint receives an output from the encrypted version of the function, and the output is used to select one or more cryptographic techniques that satisfy all of the input parameters. For example, the output of the function may allow the endpoints to determine which cryptographic techniques are compatible with the constraints and requirements of all devices involved in the aggregation process without the endpoints being aware of each other's constraints and requirements.

It is noted that, while certain operations may be described as being performed by the endpoints, some of these operations may be performed by cryptographic servers associated with the endpoints rather than by the endpoints themselves.

Techniques described herein allow a cryptographic agility system to select algorithms and/or configurations of algorithms that are best suited to the mathematical operations to be performed in the data aggregation process and to the resource constraints, performance, and/or capabilities of the device(s) and/or network(s) associated with the request, all while preserving the privacy of attributes related to individual endpoints.

In some embodiments, if homomorphic encryption is used, the multiple endpoints that send homomorphically encrypted data to an aggregation device may encrypt local data using a single encryption key that is shared across the endpoints (but not with the aggregation device) and/or may use different encryption keys, such as using a multi-key homomorphic encryption scheme (e.g., so that one endpoint is unable to decrypt the local data from another endpoint even if it were to obtain such local data). Thus, a cryptographic technique that is dynamically selected through a privacy-preserving cipher negotiation process as described herein may be, for example, a single-key homomorphic encryption technique or a multi-key homomorphic encryption technique. In some cases, such as when the endpoints are associated with independent organizations or geographic locations, a multi-key homomorphic encryption technique may be preferred to a single-key homomorphic encryption technique because of the added security, and the cipher negotiation process may select a multi-key technique accordingly.

In some embodiments, different techniques may be selected for different devices and/or networks in the same data aggregation process. For example, if processing resource availability at a given aggregator device is low (e.g., if processor utilization is high), then ciphers that support the required mathematical operations and yet have low processing requirements may be selected for that aggregator device. In another example, if network latency is high (e.g., for a satellite-based network) or if memory availability is low at a given aggregator device, then ciphers that support the required mathematical operations and yet have smaller key sizes or ciphertext sizes may be selected in order to reduce the amount of data that will need to be stored and/or transmitted over the network to implement the cryptographic algorithm for the given aggregator device. In such cases, translation between different cryptographic techniques may be performed at one or more points in the aggregation process, such as using confidential computing techniques to decrypt and re-encrypt data using a different encryption technique within a secure enclave.

In some embodiments, a variety of factors may be considered in a privacy-preserving cipher negotiation process to dynamically select an encryption technique for a privacy-preserving data aggregation process. For example, policies may be defined by users (e.g., administrators), and may specify rules for selecting and/or configuring cryptographic techniques. Policies may specify, for example, conditions under which cryptographic techniques must comply with one or more standards (e.g., Federal Information Processing Standards or FIPS), when a quantum-safe cryptographic technique must be selected, how to select among different quantum-safe cryptographic techniques, conditions for selecting key sizes (e.g., based on a desired level of security or based on different algorithm standards such as particular elliptical curves), and/or the like. In one example, cryptographic techniques (e.g., algorithms and/or configurations of algorithms) are tagged with different levels of security (e.g., rated from 0-10), and a policy associated with an application may specify that all data that is to be transmitted from the application to a destination in a given type of networking environment, such as a public network, is to be encrypted using a high-security algorithm (e.g., rated 8 or higher). Thus, if the application calls a function provided by the cryptographic agility system to encrypt an item of data for a data aggregation process, and contextual information indicates that the data is to be transmitted to a device (e.g., an aggregator device) on a public network, then the cryptographic agility system, in certain embodiments, will select a cryptographic technique tagged as a high-security technique, such as with a security rating of 8 or higher, such as in addition to being a homomorphic encryption algorithm that supports the required mathematical operations and otherwise complies with parameters from all endpoints involved in the process. In another example, a policy may specify that confidential computing is to be used for all cryptographic requests related to privacy-preserving data aggregation that are associated with a particular geographic region, organization, and/or locality and/or that homomorphic encryption is to be used for all cryptographic requests related to privacy-preserving data aggregation that are associated with another particular geographic region, organization, and/or locality. This may be due to differing preferences with respect to confidential computing and/or homomorphic encryption associated with different regions, countries, organizations, and/or the like.

By decoupling cryptographic logic from applications that rely on cryptographic functionality for performing privacy-preserving data aggregation operations, cryptographic agility techniques described herein provide flexibility and extensibility, thus allowing cryptographic techniques to be continually updated, changed, and otherwise configured without requiring modifications to the applications themselves, such as allowing for the utilization of new types of confidential computing and/or homomorphic encryption that are not natively supported by the application. Accordingly, changing circumstances may be addressed in a dynamic and efficient manner, and computing security may thereby be improved. For example, endpoints may utilize techniques described herein to dynamically select privacy-preserving cryptographic techniques for use in encrypting local parameters to send to an aggregator device, and the aggregator device may utilize techniques described herein to encrypt a global model trained based on aggregating the received local parameters from the endpoints. In some embodiments, the aggregator device may not need to encrypt the global model, as it may have been generated based on homomorphically encrypted local parameters, and thus the global model parameters may remain encrypted until they are unencrypted by the endpoints upon receipt.

According to embodiments of the present disclosure, cryptographic techniques are dynamically selected and/or configured for use in privacy-preserving data aggregation operations based on additional factors such as network and/or resource constraints. In some cases, a cryptographic algorithm may be referred to as a “cipher”. Cryptographic algorithms have varying resource requirements, such as different memory, processing, and/or communication resource requirements. For example, some algorithms are more computationally-intensive than others and some algorithms involve storage and/or transmission of larger amounts of data than others. For example, algorithms involving larger key sizes or ciphertext sizes generally require larger amounts of memory and/or network communication resources than algorithms with smaller key sizes or ciphertext sizes. In another example, the larger the number of bits of security used in an algorithm, the more processing-intensive the algorithm will generally be.

In a cryptographic agility system, an initial stage of selecting a cryptographic technique may involve ensuring that the security requirements for a given cryptographic operation, such as a level of security required by policy and/or context information, are met. However, there may be multiple algorithms and/or configurations of algorithms that meet these requirements. Thus, techniques described herein involve factoring the availability of specialized hardware, operation-related considerations (e.g., which mathematical operations are to be performed in a data aggregation process), resource-related considerations, and/or the like into the determination of which algorithms and/or configurations to use, such as based on information associated with a request and/or based on device and/or network performance metrics and/or capability information.

Cryptographic techniques may be tagged, such as by an administrator or expert, based on whether they are privacy-preserving, whether they are homomorphic, supported mathematical operations, based on resource requirements, and based on levels of security, threats protected against, and/or the like. For example, a given technique may be tagged with an indication of required hardware, supported mathematical operations (e.g., in the case of homomorphic encryption), and/or with a classification with respect to each of memory requirements, processing requirements, network resource requirements, and/or the like. Classifications may take a variety of forms, such as high, medium, and low, numerical scales (e.g., 0-10), binary indications, and/or the like. In some embodiments, classifications may be imported from one or more sources, such as cryptographic technique providers, open source entities, standards bodies, and/or the like. In some embodiments, rather than individual algorithms or configurations being tagged, types of algorithms and/or configurations are tagged with supported mathematical operations and/or classifications relating to various types of resource requirements. In one example, a tag may indicate that all “additive” homomorphic encryption algorithms support addition. In another example, a tag may indicate that all fully homomorphic encryption algorithms are associated with a high processing resource requirement. In yet another example, a tag may indicate that all confidential computing techniques are associated with a low processing resource requirement. In still another example, a tag may indicate that all techniques that involve the use of an accelerator are associated with a high processing resource requirement. An accelerator is a hardware device or a software program that enhances the overall performance of a computer, such as by processing data faster than a central processing unit (CPU) of the computer (e.g., which may be referred to as a compute accelerator). Furthermore, cryptographic techniques may be tagged with indications of capability requirements, such as whether an accelerator and/or other specialized hardware is required. In another example, cryptographic techniques are tagged with indications of whether they comply with particular standards, and a policy may specify that all data associated with a particular application or for a particular purpose is to be encrypted with a cryptographic technique that complies with a particular standard (e.g., FIPS). In such an example, if an application calls a function provided by the cryptographic agility system to encrypt an item of data, and contextual information indicates that the data relates to the particular purpose or that the application is the particular application, then the cryptographic agility system, in certain embodiments, will select a cryptographic algorithm tagged as being compliant with the particular standard.

In yet another example, cryptographic techniques are tagged with indications of whether they have certain characteristics or support certain configurations, and a policy may specify that all data that is to be transmitted as part of a federated learning process is to be encrypted using a cryptographic technique that does or does not have one or more particular characteristics or configurations. Thus, if the cryptographic agility system receives a request to encrypt an item of data for a federated learning process, then the cryptographic agility system, in certain embodiments, will select a cryptographic algorithm tagged with indications that the cryptographic algorithm does or does not have the one or more particular characteristics or configurations indicated in the policy. Accordingly, an organization or user may specify policies based on their own preferences of which characteristics or configurations of cryptographic techniques are most secure or desirable and/or based on specific compliance requirements.

When a cryptographic request is submitted by an application, the cryptographic agility system may gather information associated with the request (e.g., from the request itself and/or through communication with one or more other components) related to a privacy-preserving data aggregation process. Furthermore, the cryptographic agility system may gather information related to resource conditions and/or capabilities of the network(s) and/or device(s) related to the cryptographic request. For instance, the cryptographic agility system may gather current resource availability (e.g., based on capacity and utilization), performance metrics, capability information, and the like for the device(s) and/or network(s) to which the request relates. Techniques for gathering such information are known in the art and may involve, for example, including contextual information in the cryptographic request, communication with one or more performance monitoring components, communication with the involved devices, and/or the like. As described herein, secure multiparty computation techniques may be used to negotiate selection of a cryptographic technique among multiple endpoints based on various attributes related to the endpoints. For example, an endpoint acting as an evaluator may evaluate one or more encrypted functions, using encrypted endpoint attributes as input parameters, in order to select one or more cryptographic techniques, and may share results of the evaluation and/or selection process with the other endpoints.

In some cases, multiple cryptographic algorithms and/or configurations of algorithms may be used to service a single cryptographic request and/or for a single aggregator device. For instance, if a new, more secure cryptographic algorithm has recently become available but is not yet certified by a particular organization, and a particular cryptographic request requires cryptography that is certified by the particular organization, a certified algorithm may first be used and then the new algorithm may be used on top of the certified algorithm to provide the added level of security.

Embodiments of the present disclosure improve upon conventional cryptography techniques for data aggregation processes in which cryptographic algorithms are pre-determined for applications (e.g., at design time), in which multiple endpoints must share their local parameters with one another or with a third party in order to negotiate a cryptographic technique, and in which the aggregator device(s) are given access to the unencrypted data, by providing for the dynamic selection of privacy-preserving encryption techniques that are tailored for the operations to be performed and for the devices and networks involved, that may not be natively supported by the applications performing the federated learning processes, and without requiring sharing potentially sensitive local parameters with other endpoints. For example, by selecting targeted homomorphic encryption algorithms and/or configurations and/or confidential computing techniques based on the operations to be performed and based on network and/or resource constraints of different devices and/or networks through a privacy-preserving cipher negotiation process, techniques described herein improve the functioning of devices and networks on which cryptographic operations are performed by ensuring that cryptographic operations do not burden devices or networks beyond their capacity or capabilities while preserving the privacy of local data. As such, endpoints (e.g., edge devices) do not need to be trusted with each other's local parameters related to the cipher negotiation process, the aggregator device(s) do not need to be trusted with data access, and any of these devices can potentially be located in an untrusted networking environment (e.g., the Internet or a public cloud environment). Additionally, if homomorphic encryption is used, the aggregator device(s) do not need to decrypt the data before performing aggregation functions, thereby reducing computing resource utilization at the aggregator device(s) and improving the functioning of the computing system(s). Furthermore, embodiments of the present disclosure improve information security by ensuring that the most secure and updated cryptographic techniques that are consistent with required operations and with device and network constraints may be utilized by an application, even if such techniques were not available at the time the application was developed. Additionally, by utilizing confidential computing environments to translate between cryptographic techniques, certain embodiments of the present disclosure allow for dynamic utilization of multiple cryptographic techniques in association with a single data aggregation process while preserving the privacy of the underlying data even during decryption and re-encryption associated with cryptographic translation.

Additionally, techniques described herein may facilitate an organization's use of uniform policy configuration (e.g., a suite of coordinated policies), such as to orchestrate cryptographic usage across many endpoints (e.g., involved in a federated learning process), without requiring any given endpoint to be aware of any other endpoint's local parameters. Embodiments of the present disclosure may also be used to facilitate migration to new homomorphic encryption algorithms at scale and/or to remove deprecated homomorphic encryption algorithms from use in a centralized and coordinated manner.

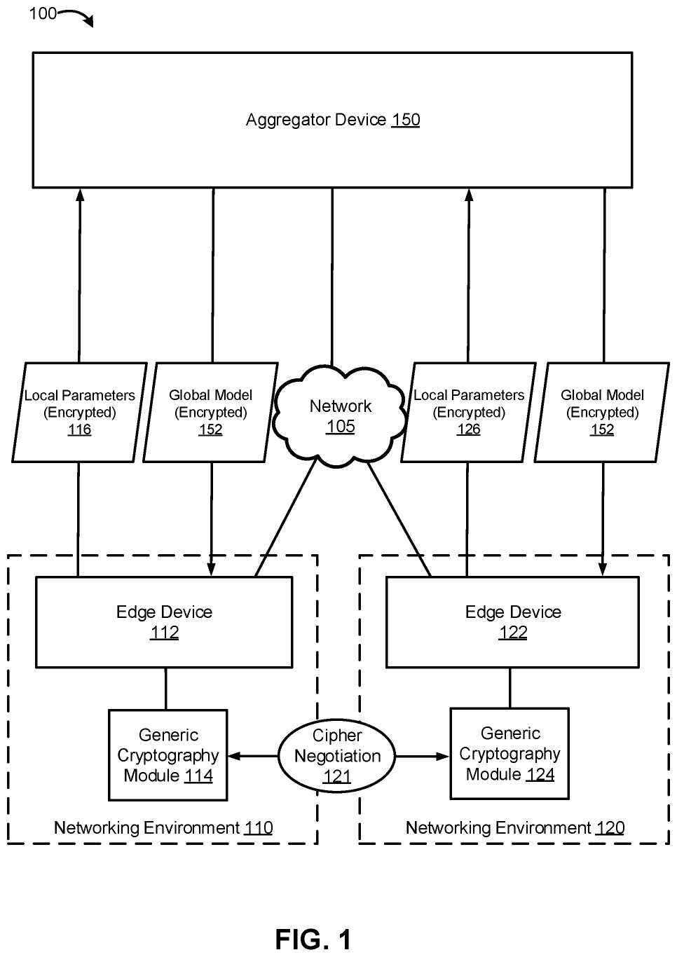

FIG. 1 is an illustration 100 of example computing components related to secure multi-endpoint cipher negotiation, according to embodiments of the present disclosure.

An example data aggregation process involves a federated learning process in which multiple endpoints, such as edge devices 112 and 122 in separate networking environments 110 and 120, send local parameters 116 and 126 to an aggregator device 150 for aggregation, and aggregator device 150 sends a global model 152 produced as a result of the aggregation back to the endpoints. It is noted that federated learning does not necessarily involve the creation of a global machine learning model and could also involve the creation of global learned parameters or determinations that are sent back to the endpoints. As such, the term model as used herein is not intended to limit federated learning processes to the creation of machine learning models. Furthermore, other types of data aggregation processes may also be performed with techniques described herein.

Networking environments 110 and 120 may be separate networks, such as data centers (e.g., physical data centers or software defined data centers), cloud environments, local area networks (LANs), and/or the like. In certain embodiments, networking environments 110 and 120 are private networking environments that implement security mechanisms (e.g., firewalls) to prevent unauthorized access. Edge devices 112 and 122 represent physical or virtual devices that provide entry points into networking environments 110 and 120. For example, in some embodiments, communications to and from networking environment 110 are received and/or transmitted via edge device 112 and communications to and from networking environment 120 are received and/or transmitted via edge device 122. Edge devices 112 and 122 communicate with an aggregator device 150 via a network 105, with may be any sort of connection over which data may be transmitted. In certain embodiments, network 105 is a wide area network (WAN) such as the Internet.

Aggregator device 150 generally represents a physical or virtual device that performs aggregation functionality for a federated learning process. Aggregator device 150 may be located, for example, in a public networking environment, such as a public cloud. In one example, aggregator device 150 is a cloud service. In other examples, aggregator device may be located in one of networking environments 110 or 120 and/or may be located in a different private or public networking environment.

Aggregator device 150 may optionally include a confidential computing component, such as a secure processor enclave of a processing device. A confidential computing component generally refers to a hardware-backed secure environment that shields code and data from observation or modification by any components outside of the secure environment, thus reducing the burden of trust on a computer's operating system or hypervisor while allowing computations to be performed on the data within the secure environment. Such a confidential computing component may, for example, provide a secure environment through a partitioning process in which the central processing unit (CPU) places hardware checks on the memory allocated to each component such as a virtual machine (VM) on aggregator device 150 and ensures these boundaries are not crossed, or through a memory encryption process in which the CPU automatically encrypts VM memory with different keys for different VMs. A confidential computing component may also provide such a secure environment through a combination of these techniques, and/or through one or more other techniques.

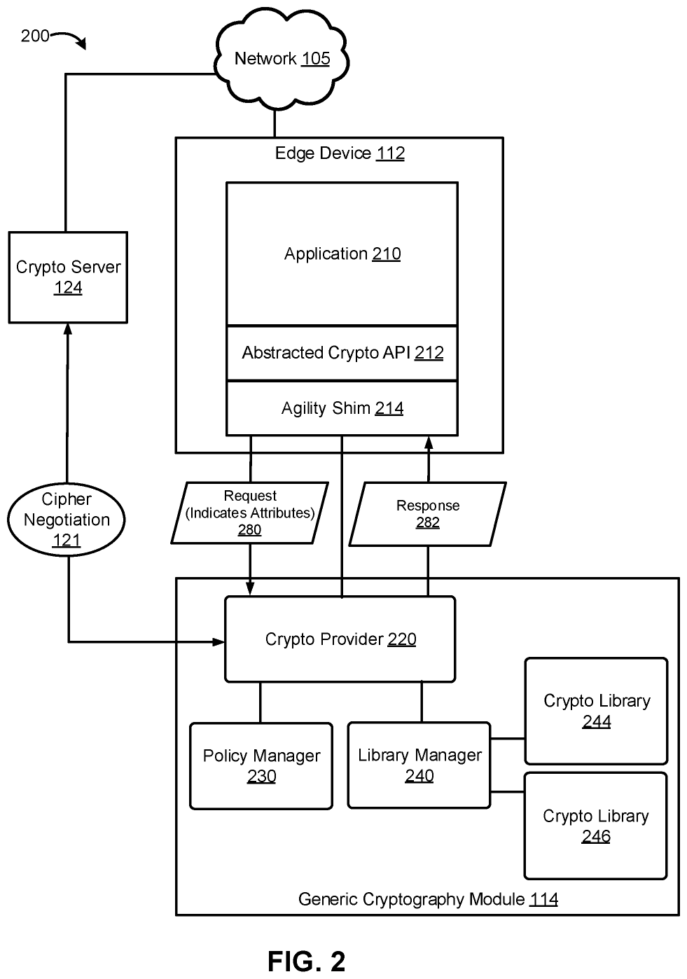

Edge devices 112 and 122 communicate with generic cryptography modules 114 and 124 in order to perform cryptographic functionality related to the federated learning process. As described in more detail below with respect to FIG. 2, generic cryptography modules 114 and 124 may be physical or virtual computing devices, such as server computers or virtual computing instances (VCIs), on which components of a cryptographic agility system reside. For example, generic cryptography modules 114 and 124 generally perform operations related to dynamically selecting cryptographic techniques (e.g., based on contextual information related to requests for cryptographic operations), performing the requested cryptographic operations according to the selected techniques, and providing results of the operations to the requesting components. It is noted that while generic cryptography modules 114 and 124 are shown as separate devices from edge devices 112 and 122 in networking environments 110 and 120, these generic cryptography modules may alternatively be implemented on the same devices as edge devices 112 and/or 122 (e.g., as separate software components).

In an example, edge devices 112 and 122 send requests to generic cryptography modules 114 and 124 to encrypt local data (e.g., local model parameters determined through a local model training process based on local training data), such as indicating that the requests relate to a privacy-preserving data aggregation process, indicating one or more attributes of edge devices 112 and 122, indicating one or more attributes of aggregator device 150, indicating one or more types of mathematical operations to be performed by aggregator device 150, and/or the like in the requests. Generic cryptography modules 114 and 124 dynamically select one or more cryptographic techniques such as involving confidential computing or homomorphic encryption algorithms based on attributes associated with the request, such as whether required specialized hardware is available, the operations to be performed, other computing resource and/or capability constraints, policy considerations, and/or the like. Generic cryptography modules 114 and 124 communicate with each other to perform a cipher negotiation 121, such as via a secure channel established between them, to coordinate aspects of the one or more selected encryption techniques.

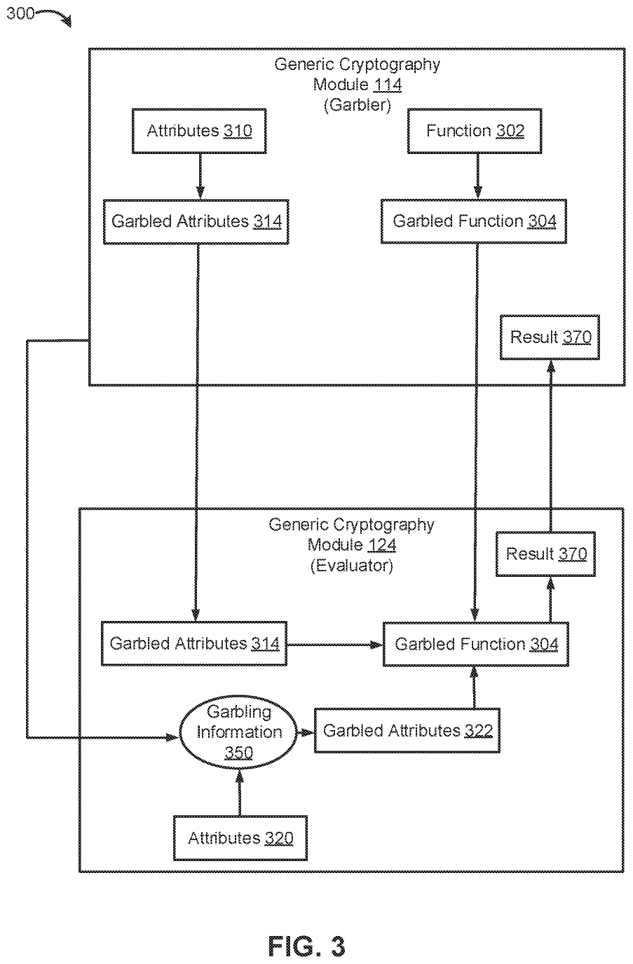

As described in more detail below with respect to FIG. 3, cipher negotiation 121 may involve a secure computation process by which one or more encryption techniques are selected to service the requests from edge devices 112 and 122 based on encrypted attributes associated with the request. For example, an encrypted function may be generated that accepts encrypted inputs and produces a result that matches a result that would be produced by providing the unencrypted inputs to the unencrypted function. In some cases, more than one such encrypted function is used. The results of evaluating the encrypted function(s) are used to select one or more cryptographic techniques that comply with the parameters. The unencrypted local parameters of edge device 112 and 122 known to generic cryptography modules 114 and 124 are not shared between networking environments 110 and 120. Thus, parameters of both edge devices 112 and 122 may be used to select one or more cryptographic techniques while preserving the privacy of the parameters.

In an example, after selecting a cryptographic technique based on cipher negotiation 121, generic cryptography modules 114 and 124 may securely share an encryption key that is used at both generic cryptography modules 114 and 124 to encrypt local data. In another example, generic cryptography modules 114 and 124 coordinate a multi-key homomorphic encryption scheme with one another so that a key does not need to be shared between generic cryptography modules 114 and 124. In some embodiments, generic cryptography modules 114 and 124 coordinate with a generic cryptography module associated with aggregator device 150 as well, such as indicating a selected encryption technique.

After dynamically selecting one or more encryption techniques, generic cryptography modules 114 and 124 may encrypt the respective local data using the selected technique(s) and return the respective encrypted local data to edge devices 112 and 122. In alternative embodiments, generic cryptography modules 14 and 124, rather than performing encryption themselves, may provide information to one or more other components, such as edge devices 112 and 122 and/or other encryption components, to perform the selected encryption technique(s).

If the selected technique involves homomorphic encryption, then the encrypted data can be sent to aggregator device 150 without any encryption key being provided to aggregator device 150, and aggregator device 150 can perform computations on the encrypted data without decryption. If the selected technique involves confidential computing, the data will be encrypted using an encryption algorithm (e.g., non-homomorphic) that otherwise complies with requisite factors, and one or more keys may be sent by generic cryptography module 114 and/or 124 via a secure channel directly to a confidential computing component on aggregator device 150 so that the encrypted data can be securely unencrypted within the confidential computing component using the key(s) in order to perform computations and the result of the computations can be encrypted within the confidential computing component using the key(s).

Edge devices 112 and 122 send the encrypted local parameters 116 and 126 to aggregator device 150, which performs aggregation functionality. For example, in the case of homomorphic encryption, aggregator device 150 may perform one or more mathematical operations, such as addition, subtraction, division, and/or multiplication in order to aggregate encrypted local parameters 116 and 126. In one example, aggregator device 150 calculates an average of encrypted local parameters 116 and 126 by adding encrypted local parameters 116 and 126 and dividing the sum by the total number of edge devices involved in the federated learning process (e.g., which is two in the depicted example). In another example, in the case of confidential computing, aggregator device 150 may provide the encrypted local parameters 116 and 126 to a confidential computing component, such as along with instructions to perform one or more mathematical operations, such as addition, subtraction, division, and/or multiplication in order to aggregate encrypted local parameters 116 and 126. In such cases, encrypted local parameters 116 and 126 are decrypted within the confidential computing component (such that the unencrypted parameters cannot be accessed outside of the confidential computing component), the computations are performed to produce a result, and the result is encrypted before being sent outside of the confidential computing component. If encrypted local parameters 116 and 126 were encrypted using different encryption techniques and/or keys (e.g., which may have been separately provided to the confidential computing component by generic cryptography module 114 and generic cryptography module 124), then the confidential computing component may encrypt the result of the computations with a first key/technique corresponding to generic cryptography module 124 for sending the encrypted result to crypto edge device 112 and also encrypt the result of the computations with a second key/technique corresponding to generic cryptography module 114 for sending the encrypted result to edge device 122. Thus, each endpoint can decrypt the encrypted global model 152. Alternatively, the confidential computing component may encrypt the result of the computations using a different encryption technique altogether, and may send one or more encryption keys securely to generic cryptography modules 114 and 124 for use in decrypting encrypted global model 152.

It is noted that in many embodiments the number of participating endpoints (e.g., edge devices) will be larger than two. Furthermore, participating endpoints need not be edge devices, and edge devices are included as an example. Additionally, aggregation is not limited to averaging, and other types of aggregation computations may alternatively be performed. The local parameters that are aggregated to produce global parameters may include, for example, gradients, weights, hyperparameters, and/or the like.

The results of computations performed by aggregator device 150 on encrypted local parameters 116 and 126 will remain encrypted, such that aggregator device 150 will not have access to the unencrypted local parameters or the unencrypted global parameters (e.g., outside of a confidential computing component in the case of confidential computing). Aggregator device 150 sends an encrypted global model 152 (e.g., produced as a result of the aggregation functionality, such as comprising the encrypted global parameters, which may in one example be the average of the local parameters) to edge devices 112 and 122.

Edge devices 112 and 122 may decrypt the encrypted global model 152 using the key(s) with which encrypted local parameters 116 and 126 were encrypted (or key(s) received from confidential computing component 156) in order to determine the unencrypted global model. For example, edge devices 112 and 122 may send requests to generic cryptography modules 114 and 124 to decrypt the encrypted global model 152, and generic cryptography modules 114 and 124 may perform decryption and return the unencrypted global model to edge devices 112 and 122. In the case of homomorphic encryption, the unencrypted global model will be the same as if the computations performed by aggregator device 150 has been performed on the unencrypted local data from edge devices 112 and 122. In the case of confidential computing, the computations were performed on the unencrypted local data but within a secure environment. Thus, edge devices 112 and 122 are provided with a global model that benefits from the local training performed at all endpoints without being biased by peculiar attributes of local training data from any individual endpoint. Furthermore, the privacy of the local data is preserved, as aggregator device 150 is never granted access to the unencrypted local data or the unencrypted global data (e.g., outside of confidential a computing component in the case of confidential computing), and the unencrypted local data is never shared between different endpoints. Additionally, computing resource constraints and capabilities of the computing devices and networks are respected through the dynamic selection of encryption techniques based on such constraints and capabilities, such as selecting one or more confidential computing or homomorphic encryption techniques that are consistent with available hardware, that support the particular mathematical operations that are to be performed by aggregator device 150 (and that comply with one or more additional policies), and/or that also are well-suited to the devices and networks involved in the federated learning process. Through the privacy-preserving nature of cipher negotiation 121, the parameters of edge device 112 are not shared in unencrypted form with generic cryptography module 124 or edge device 122 and the parameters of edge device 122 are not shared in unencrypted form with generic cryptography module 114 or edge device 112. As such, the potentially sensitive local attributes of the edge devices, such as preferences, computing resource constraints, capabilities, and/or the like, are not revealed to other edge devices or networking environments.

It is noted that while certain embodiments are described in which an aggregator device performs aggregation on encrypted data from endpoints and sends results of the aggregation back to the endpoints, other embodiments may involve the aggregation device acting as a sort of middle box that performs aggregation on encrypted data from endpoints and then sends results of the aggregation to one or more different endpoints (e.g., different than the endpoints from which the encrypted data was received). For example, the one or more different endpoints may be provided one or more decryption keys (e.g., used to generate the encrypted data) by the one or more endpoints, and the one or more different endpoints may use the one or more decryption keys to decrypt the results of the aggregation received from the aggregation device.

FIG. 2 is an illustration 200 of an example related to dynamic cryptographic technique selection for privacy-preserving data aggregation, according to embodiments of the present disclosure. Illustration 200 includes network 105, edge device 112, and generic cryptography module 114 of FIG. 1.

Edge device 112 may be a physical or virtual computing device, such as a server computer, that runs an application 210. In some embodiments, edge device 112 may be a virtual computing instance (VCI), such as a virtual machine (VM) or container that runs on a physical host computer that includes one or more processors and/or memory devices. It is noted that edge device 112 is included as an example computing device on which application 210 and/or associated components may be located, and other types of devices may also be used.

Application 210 generally represents a software application that requires cryptographic functionality. For example, application 210 may rely on cryptographic functionality to encrypt data that it transmits over a network (e.g., network 105), such as to aggregator device 140 of FIG. 1, such as within a data aggregation process in which multiple aggregator devices are involved. In one example, application 210 performs operations related to federated learning, such as sending local model parameters (e.g., which may have been generated at edge device 112 and/or one or more other devices involved in a local model training process based on local training data) to one or more aggregator devices for aggregation with local parameters from other edge devices. While conventional techniques generally involve direct integration of cryptographic libraries with applications that rely on cryptographic functionality, such as for transmitting data associated with a federated learning process, techniques described herein involve abstracting cryptographic functionality away from such applications. As such, an agility shim 214 provides an abstracted crypto application programming interface (API) 212 as a means of interaction between application 210 and a separate cryptographic agility system. Application 210 may call generic cryptographic functions of abstracted crypto API 212 in order to invoke particular cryptographic functionality, and the cryptographic agility system may select cryptographic techniques and perform cryptographic operations in response to the function invocations based on contextual information (e.g., including the hardware capabilities of one or more devices, types of mathematical operations to be performed, resource constraints, and/or the like). Thus, application 210 may be merely a consumer of cryptography provided by the separate cryptographic agility system, rather than implementing cryptography itself.

The cryptographic agility system includes agility shim 214 and abstracted crypto API 212 as well as crypto provider 220, policy manager 230, and library manager 240. In some embodiments, while depicted as separate components, the functionality associated with agility shim 214, abstracted crypto API 212, policy manager 230, and/or library manager 240 may be part of crypto provider 220 and/or may be implemented by more or fewer components. In certain embodiments, abstracted crypto API 212 and/or agility shim 214 are part of application 210. In alternative embodiments, abstracted crypto API 212 and/or agility shim 214 may be located on a separate device from edge device 112, such as on generic cryptography module 114 or a different computing device.

Agility shim 214 may comprise a library, and generally intercepts API calls (e.g., calls to functions of abstracted crypto API 212) and redirects them to crypto provider 220. Shims generally allow new software components to be integrated with existing software components by intercepting, modifying, and/or redirecting communications. As such, agility shim 214 allows application 210 to interact with crypto provider 220 even though application 210 may have no knowledge of crypto provider 220. For instance, application 210 may make generic function cryptographic function calls (e.g., requesting that an item of data be encrypted), and these generic function calls may be intercepted by agility shim 214 and redirected to crypto provider 220.

It is noted that while embodiments of the present disclosure are depicted on edge device 112 and generic cryptography module 114, alternative embodiments may involve various components being located on more or fewer computing devices. In some cases, aspects of the cryptographic agility system may be implemented in a distributed fashion across a plurality of computing devices. In certain embodiments, said components may be located on a single computing device.

In certain embodiments, generic cryptography module 114 comprises a physical or virtual computing device, such as a server computer, on which components of the cryptographic agility system, such as crypto provider 220, policy manager 230, and/or library manager 240, reside. For example, generic cryptography module 214 may represent a VCI or a physical computing device. Generic cryptography module 214 may be connected to network 105 and/or one or more additional networks (e.g., networking environment 110 of FIG. 1).

Crypto provider 220 generally performs operations related to dynamically selecting cryptographic techniques (e.g., based on contextual information related to requests for cryptographic operations, such as whether specialized hardware is available, the types of mathematical operations to be performed at one or more aggregator devices in a federated learning process, and/or the like), performing the requested cryptographic operation(s) according to the selected technique(s), and providing results of the operation(s) to the requesting components. Cryptographic techniques may include the use of cryptographic algorithms (e.g., included in one or more libraries), and/or specific configurations of cryptographic algorithms, as described herein. In some embodiments, the cryptographic agility system is located on the same device as application 210, while in other embodiments the cryptographic agility system is located on a separate device, such as on a server that is accessible over a network. Crypto provider 220's selection of cryptographic techniques may be based on a cipher negotiation 121 between crypto provider 220 and a corresponding crypto provider on generic cryptography module 124 (e.g., which may be associated with a separate edge device in a separate network, such as edge device 122 of FIG. 1).

In certain aspects, crypto provider 220 has two major subsystems, policy manager 230 and library manager 240. Policy manager 230 performs operations related to cryptographic policies, such as receiving policies defined by users and storing information related to the policies, such as in a policy table. In an example, a policy is based on one or more of an organizational context and a user context related to a cryptographic request.

Organizational context may involve geographic region (e.g., country, state, city and/or other region), industry mandates (e.g., security requirements of a particular industry, such as related to storage and transmission of medical records), government mandates (e.g., laws and regulations imposed by governmental entities, such as including security requirements), and the like. For instance, a policy may indicate that if a cryptographic request is received in relation to a device associated with a particular geographic region, associated with a particular industry, and/or within the jurisdiction of a particular governmental entity, then crypto provider 220 must select a cryptographic technique that meets one or more conditions (e.g., having a particular security rating, being configured to protect against particular types of threats, and/or involving confidential computing or homomorphic encryption) in order to comply with relevant laws, regulations, preferences, or mandates.

User context may involve user identity (e.g., a user identifier or category, which may be associated with particular privileges), data characteristics (e.g., whether the data is sensitive, classified, or the like), application characteristics (e.g., whether the application is a business application, an entertainment application, or the like), platform characteristics (e.g., details of an operating system), device characteristics (e.g., hardware configurations and capabilities of the device, resource availability information, and the like), device location (e.g., geographic location information, such as based on a satellite positioning system associated with the device), networking environment (e.g., a type of network to which the device is connected, such as a satellite or land-based network connection), and/or the like. For example, a policy may indicate that if a cryptographic request is received with respect to a particular category of user (e.g., administrators, general users, or the like), relating to a particular type of data (e.g., tagged as sensitive or meeting characteristics associated with sensitivity, such as being financial or medical data, or being associated with privacy-preserving data aggregation), associated with a particular application or type of application, associated with a particular platform (e.g., operating system), with respect to a device with particular capabilities or other attributes (e.g., having a certain amount of processing or memory resources, having an accelerator, having one or more particular types of processors, and/or the like), with respect to a device in a particular location (e.g., geographic location) or type of networking environment (e.g., cellular network, satellite-based network, land network, or the like), and/or that is to be transmitted to a device having one or more particular characteristics (e.g., being untrusted, being located in a public networking environment, being located in a particular geographic region, having specialized hardware, and/or the like), then crypto provider 220 should select a cryptographic technique that meets one or more conditions.

In one example, a policy indicates that if a request relates to encrypting data that is to be transmitted to a device that is untrusted for one or more reasons for computation to be performed on the data, then a confidential computing or homomorphic encryption technique should be selected. In certain embodiments, a policy may specify that, unless otherwise required (e.g., because of another policy, such as related to security level), when homomorphic encryption is used, a homomorphic encryption technique that supports the required mathematical operations while having the lowest resource utilization requirements of all such homomorphic encryption techniques is to be selected. In some cases, a policy may relate to resource constraints (e.g., based on available processing, memory, network, physical storage, accelerator, entropy source, or battery resources), such as specifying that cryptographic techniques must be selected based on resource availability (e.g., how much of a device's processing and/or memory resources are currently utilized, how much latency is present on a network, and the like) and/or capabilities (e.g., whether a device is associated with an accelerator) associated with devices and/or networks, while in other embodiments crypto provider 220 selects cryptographic techniques based on resource constraints and/or supported mathematical operations independently of policy manager 230 (e.g., for all applicable cryptographic requests regardless of whether any policies are in place). For example, policies may only relate to security levels of cryptographic techniques, such as requiring the use of cryptographic techniques associated with particular security ratings when certain characteristics are indicated in contextual information related to a cryptographic request, and resource constraints may be considered separately from policies.

Attributes, such as policies, organizational context information, user context information, and/or the like may include sensitive data. Thus, techniques described herein for privacy-preserving cipher negotiation 121 between endpoints may allow such sensitive data to be taken into account in a multi-endpoint cipher negotiation without disclosing such sensitive data between endpoints or their networking environments.

In one example, as part of cipher negotiation 121 between the involved endpoints, once all cryptographic techniques meeting the security requirements, hardware requirements, and/or mathematical operation requirements for a cryptographic request are identified (e.g., based on policies or otherwise), a cryptographic technique is selected from these compliant cryptographic techniques based on resource constraints.

It is noted that resource constraints and/or capabilities may include a variety of different types of information, such as processor availability and/or capabilities (e.g., clock rate, number of cores, instruction-level features such as single instruction multiple data (SIMD) instructions, types of processors, inclusion of secure enclaves, and/or the like) memory availability and/or capabilities (e.g., memory size and performance), accelerator capabilities (e.g., hardware-based cryptographic accelerator units available for use with the device), battery capabilities (e.g., lifetime, current power remaining, and/or the like), information about entropy (e.g., how much entropy is available for random numbers, whether available entropy sources are federal information processing standards (FIPS) compliant, and/or the like), network connectivity information (e.g., bandwidth, loss metrics for the channel, congestion, latency, and/or the like), information about the device's physical exposure to potential side-channel attacks and/or ease of side channel analysis, and/or the like. Thus, any of these types of data points may be gathered from devices and/or networks, and may be used in selecting cryptographic techniques (e.g., based on policies and/or tags related to these data points associated with cryptographic techniques).

A policy table may store information related to policies. In some embodiments, a policy table maps various contextual conditions (e.g., relating to organizational context and/or user context) to cryptographic technique characteristics (e.g., whether techniques are privacy-preserving, homomorphic, involve confidential computing, require specialized hardware, support certain mathematical operations, have certain security ratings, protect against certain threats, have certain resource utilization ratings, and the like). For example, a contextual condition may be the use of a certain type of application, the requirement that privacy be preserved during computation, the requirement of certain mathematical operations to be performed on encrypted data, a certain type of data, or a particular geographic location. A cryptographic technique characteristic may be, for example, whether the cryptographic technique is homomorphic, whether the cryptographic technique involves confidential computing and/or requires certain specialized hardware, supported mathematical operations, a security rating (e.g., 0-10), whether the cryptographic technique is quantum-safe, what level of resource requirements the cryptographic technique has for a particular type of resource (e.g., memory, processor, or network resources), or the like. Thus, when cryptographic requests are received, a policy table may be used to determine whether the cryptographic requests are associated with any characteristics included in policies and, if so, what cryptographic technique characteristics are required by the policies for servicing the requests.

Library manager 240 generally manages cryptographic libraries containing cryptographic algorithms and/or techniques. For example crypto libraries 244 and 246 each include various cryptographic algorithms and/or techniques, each of which may include configurable parameters, such as key size or ciphertext size. For instance, cryptographic techniques (e.g., algorithms and/or specific configurations of algorithms, and/or confidential computing techniques) may be registered with library manager 240 along with information indicating characteristics of the cryptographic techniques. Examples of algorithms include the Paillier cryptosystem, the Boneh-Goh-Nissim cryptosystem, the Rivest-Shamir-Adleman (RSA) cryptosystem, the Gentry cryptosystem(s), the Brakerski-Gentry-Vaikuntanathan (BGV) cryptosystem(s), the Cheon, Kim, Kim and Song (CKKS) cyrptosystem(s), the Clear and McGoldrick multi-key homomorphic cryptosystem, data encryption standard (DES), triple DES, advanced encryption standard (AES), and others. There are many other types of encryption algorithms, including homomorphic and non-homomorphic encryption algorithms, and the algorithms listed herein are included as examples. Some algorithms may, for example, involve symmetric key encryption or asymmetric key encryption. A configuration of an algorithm may include values for one or more configurable parameters of the algorithm, such as key size, size of lattice, which elliptic curve is utilized, number of bits of security, whether accelerators are used, ciphertext size, and/or the like. Cryptographic techniques may also involve confidential computing techniques, which may rely on the use of specialized hardware, such as Intel® Software Guard Extensions (SGX), Project Amber, Intel® Trust Domain Extensions (TDX), Arm® TrustZone®, and/or the like. A characteristic of a cryptographic technique may be, for example, whether the cryptographic technique is privacy-preserving, whether the cryptographic technique involves confidential computing, whether the cryptographic technique is homomorphic, what types of specialized hardware are required for the cryptographic technique, supported mathematical operations, whether the technique is Turing complete (e.g., supports all types of mathematical operations, such as a fully homomorphic encryption scheme), a security rating, a resource requirement rating, whether the technique requires an accelerator, whether the technique is quantum-safe, or the like. A cryptographic technique may include more than one cryptographic algorithm and/or configuration. In an example, each cryptographic technique is tagged (e.g., by an administrator) based on characteristics of the technique, such as with an indication of whether the cryptographic technique is privacy-preserving, whether the cryptographic technique is homomorphic, what types of specialized hardware are required for the cryptographic technique, an indication of supported mathematical operations, a security rating, an indication of threats protected against by the technique, indications of the resource requirements of the technique, and/or the like.

Information related to cryptographic techniques registered with library manager 240 may be stored in an available algorithm/configuration table. For instance, an available algorithm/configuration table may store identifying information of each available cryptographic technique (e.g., an identifier of a library, an identifier of an algorithm or technique in the library, and/or one or more configuration values for the algorithm) associated with tags indicating characteristics of the technique. It is noted that policies and tags are examples of how cryptographic techniques may be associated with indications of characteristics, and alternative implementations are possible. For instance, rather than associating individual cryptographic techniques with tags, alternative embodiments may involve associating higher-level types of cryptographic techniques with tags, and associating individual cryptographic techniques with indications of types. For example, a higher-level type of cryptographic technique may be “homomorphic encryption algorithms configured to support addition.” Thus, if tags are associated with this type (e.g., including supported mathematical operations, security ratings, recourse requirement ratings, and the like), any specific cryptographic techniques of this type (being homomorphic encryption algorithms, and being configured to support addition) will be considered to be associated with these tags. In another example, fuzzy logic and/or machine learning techniques may be employed in the selection and/or negotiation of cryptographic techniques, such as based on historical cryptographic data indicating which cryptographic techniques were utilized for cryptographic requests having particular characteristics.

By allowing cryptographic techniques and libraries, including new homomorphic encryption techniques that may become available due to the ongoing research into such techniques, to be registered and deregistered with library manager 240 on an ongoing basis, embodiments of the present disclosure allow the pool of possible cryptographic techniques to be continuously updated to meet new conditions and threats. For example, as new libraries and/or techniques are developed, these libraries and/or techniques may be added to library manager 240, and such cryptographic techniques may be used by crypto provider 220 in servicing requests from application 210 without application 210 having any awareness of the new libraries and/or techniques. Similarly, by managing policies and libraries separately, policies may be defined in an abstract manner (e.g., based on characteristics of requests and cryptographic techniques) such that policies may be satisfied through the selection of new cryptographic techniques that were not known at the time of policy creation.

In one particular example, a new cryptographic technique is tagged as being fully homomorphic (e.g., Turing complete), meaning that the cryptographic technique was developed to support all types of mathematical operations in a homomorphic manner. For instance, the new cryptographic technique may have a high security rating (e.g., 10 out of 10) as well as high resource requirements. The new cryptographic technique is registered with library manager 240, and information about the new cryptographic technique and its characteristics is stored in an available algorithm/configuration table. Thus, the new cryptographic technique is available to be selected by crypto provider 220 for servicing cryptographic requests from application 210.

Continuing with the example, a policy at one of the edge devices involved in an aggregation process states that cryptographic requests relating to data that is to be sent to an aggregator device for aggregation as part of a federated learning process is to be encrypted using a fully homomorphic technique if such a technique is available, unless device and/or network resource constraints prohibit the use of such a technique. Thus, when application 210 submits a cryptographic request 280 (e.g., via a call to a generic cryptographic function provided by abstracted crypto API 212) to encrypt an item of data that is to be sent to an aggregator device for aggregation as part of a federated learning process, crypto provider 220 determines based on information stored in the policy table (and/or based on cipher negotiation 121) that a fully homomorphic cryptographic technique is to be used if possible. Crypto provider 220 determines based on information in the available algorithm/configuration table that the new cryptographic technique is fully homomorphic. Crypto provider 220 may also analyze resource constraints related to the cryptographic request 280 (e.g., as part of cipher negotiation 121) to determine if the new cryptographic technique can be performed. If crypto provider 220 determines that the device and/or network associated with application 210 can support the new cryptographic technique (e.g., based on available resources, which may be considered as part of cipher negotiation 121), then crypto provider 220 selects the new cryptographic technique for servicing the cryptographic request 280, and provides a response 282 to application 210 (e.g., via agility shim 214) accordingly. However, if crypto provider 220 determines that the device and/or network associated with application 210 cannot support the new cryptographic technique (e.g., based on available resources), then crypto provider 220 selects a different cryptographic technique for servicing the cryptographic request 280, such as a different homomorphic encryption technique that supports the mathematical operations indicated in request 280 and that otherwise complies with the resource constraints of the devices and/or networks, and provides a response 282 to application 210 (e.g., via agility shim 214) accordingly. In some embodiments, the request indicates that multiple aggregator devices are involved in the aggregation process, and indicates attributes of each aggregator device, such as operations to be performed at each aggregator device and resource constraints of each aggregator device. In such as case, crypto provider 220 may select a different cryptographic technique for each aggregator device, and (as needed) information related to one or more of the selected cryptographic techniques may be sent to a confidential computing component of a cryptographic translator server for use in translating between the selected cryptographic techniques.

In some cases, the response sent from crypto provider 220 to application 210 includes data encrypted using the selected technique. In other cases, the response includes information related to performing the selected technique(s) to encrypt the data, and the encryption is performed on the device from which the request was sent. In still other cases, one or more other components and/or devices may be involved in performing the encryption according to the technique(s) selected by crypto provider 220.

Generic cryptography module 124 may also determine which cryptographic technique(s) to use based on cipher negotiation 121. For example, generic cryptography modules 114 and 124 may negotiate a common one or more cryptographic techniques to utilize for related requests through cipher negotiation 121.

In some cases, more than one cryptographic technique may be selected for servicing a given cryptographic request, even for a single aggregator device. For instance, an item of data may first be encrypted using a first technique (e.g., that satisfies one or more first conditions related to policy and/or resource considerations) and then the encrypted data may be encrypted again using a second technique (e.g., that satisfies one or more second conditions related to policy and/or resource considerations).

There may be cases where there is no available cryptographic technique that complies with all policies, privacy-preservation constraints, device constraints, resource constraints, and operation constraints and so trade-offs may be made (e.g., in accordance with policies and/or logic governing such cases), such as selecting a cryptographic technique that is not fully compliant with one or more of these factors (e.g., if certain factors are non-mandatory), or certain cryptographic requests may be declined as impossible under the circumstances. For example, cipher negotiation 121 may produce a result indicating that no cryptographic techniques that comply with all parameters are available.

FIG. 3 is an illustration 300 of an example related to secure multi-endpoint cipher negotiation. Illustration 300 includes generic cryptography modules 114 and 124 of FIGS. 1 and 2. Illustration 300 may, for example, correspond to cipher negotiation 121 of FIGS. 1 and 2.

In an example garbling technique, generic cryptography module 114 takes on the role of the garbler and generic cryptography module 124 takes on the role of the evaluator. Generic cryptography module 114 generates a garbled function 304 based on a function 302, and provides garbled function 304 to generic cryptography module 124. Function 302 may represent logic related to dynamic selection of cryptographic techniques based on various attributes, such as accepting attributes related to devices as inputs and producing an output that can be used to select a cryptographic technique that complies with the input attributes. In some embodiments, when provided with attributes related to a cryptographic request as inputs, function 302 outputs an indication of one or more particular cryptographic techniques, types or classes of cryptographic techniques, and/or attributes of cryptographic techniques that comply with the input parameters. Garbled function 304 is generated in such a manner that when garbled function 304 is provided with encrypted input parameters, it produces an output that matches what the output would be if function 302 were provided with the unencrypted versions of the encrypted input parameters. Examples of generating such a function are described above with respect to constructing a new function ƒ′ that preserves the functionality of a function ƒ but also preserves the privacy of the inputs, and are known in the art.

Generic cryptography module 114 also generates garbled attributes 314 based on attributes 310. For example, attributes 310 may relate to generic cryptography module 114 and/or an edge device associated with generic cryptography module 114, and may include sensitive information. Examples of attributes 310 are described above, such as with respect to policy manager 230 of FIG. 1 and elsewhere. Attributes 310 may include any type of factors, preferences, or other data points that relate in some way to generic cryptography module 114 and may be used to select a cryptographic technique. Garbled attributes 314 are generated based on a garbling technique used to generate garbled function 304, such that garbled attributes 314 can be provided to garbled function 304 to obtain the same result that would be obtained by providing attributes 310 to function 302. Examples of generating such garbled attributes are described above with respect to transforming an input x₁ into a ‘garbled’ input x′₁, and are known in the art. Generic cryptography module 114 provides garbled attributes 314 to generic cryptography module 124.

Generic cryptography module 114 also provides garbling information 350 to generic cryptography module 124. Garbling information 350 generally represents information that generic cryptography module 124 can use to generate garbled attributes 322 based on its own attributes 320 such that providing garbled attributes 320 to garbled function 304 produces the same result that would be produced if attributes 320 were provided to function 302. Techniques for providing such garbling information are described above with respect the garbler helping the evaluator to transform its input x₂ into a ‘garbled’ input x′₂, and are known in the art. For example, garbling information 350 may include a mapping of possible attribute values to encrypted versions of those attribute values, such as with respect to one or more particular input wires of garbled function 304. In another example, garbling information 350 includes an encryption key. It is noted that garbling information 350 is generated such that it cannot be used by generic cryptography module 124 to decrypt garbled attributes 314 received from generic cryptography module 114.

Generic cryptography module 124 uses garbling information 350 to create garbled attributes 322 based on attributes 320 (which include attributes related to generic cryptography module 124 and/or an associated edge device). Generic cryptography module 124 then evaluates garbled function 304 based on garbled attributes 314 and garbled attributes 322 (e.g., providing garbled attributes 314 and garbled attributes 322 as inputs to garbled function 304) to produce result a result 370. Result 370 may indicate one or more cryptographic techniques, one or more types or classes of cryptographic techniques, and/or one or more attributes of cryptographic techniques that comply with attributes 310 and attributes 320. Result 370 may be shared by generic cryptography module 124 with generic cryptography module 114, and is used to select one or more cryptographic techniques for use in a privacy-preserving data aggregation process. For example, result 370 may indicate a minimum level of security required by all involved parties, a maximum amount or level of processor, memory, or network resource utilization allowed by all parties, whether confidential computing is supported, what types of homomorphic encryption may be used, whether homomorphic encryption or confidential computing is preferred, and/or other data points related to selection of one or more cryptographic techniques.

In some embodiments, result 370 is used as one factor in selecting one or more cryptographic techniques. For example, privacy-preserving cipher negotiation techniques may be used for potentially sensitive attributes, but other attributes (e.g., that are common to all endpoints or otherwise not sensitive) may be considered separately, such as in conjunction with results of a secure computation process that is used for sensitive attributes. For example, one or more cryptographic techniques that comply with result 370 and also comply with one or more other factors (e.g., the types and/or numbers of mathematical operations to be performed by an aggregator device) may be selected.

It is noted that garbling is included as an example of a secure computation technique, and other secure computation techniques that preserve the privacy of the input values may also be used.

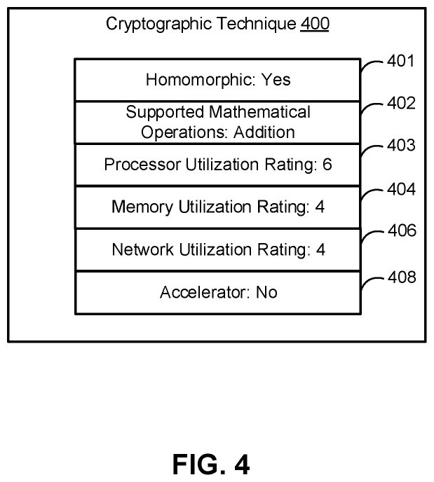

FIG. 4 depicts an example of tagging cryptographic techniques based on attributes, according to embodiments described herein.

A cryptographic technique 400 comprises one or more cryptographic algorithms and/or configurations of algorithms. For instance cryptographic technique 400 may be included in a cryptographic library, and may be registered with library manager 240 of FIG. 2 as an available cryptographic technique for use in a cryptographic agility system.

Tags 401, 402, 403, 404, 406, and 408 are associated with cryptographic technique 400 to indicate characteristics of cryptographic technique 400. For example, these tags may be added by an administrator at the time cryptographic technique 400 is registered with library manager 240 of FIG. 2. While not depicted, cryptographic technique 400 may also be associated with other tags related to, for example, a security level of cryptographic technique 400, threats protected against by cryptographic technique 400, whether cryptographic technique 400 is quantum-safe, and/or the like.

Tags 401, 402, 403, 404, 406, and 408 may be based on a variety of characteristics of cryptographic technique 400, such as the nature of involved cryptographic algorithm(s), key size, size of lattice, which elliptic curve is utilized, number of bits of security, whether accelerators are used, ciphertext size, whether side channel attacks are protected against (e.g., resulting in higher resource usage), and/or the like.

Tag 401 indicates that cryptographic technique 400 is a homomorphic encryption technique.

Tag 402 indicates that cryptographic technique 400 supports the mathematical operation of addition, such as meaning that addition can be performed on data encrypted using cryptographic technique 400 without decryption in order to produce an encrypted result that, when decrypted using cryptographic technique 400, is the same as the result would have been if the addition operation had been performed on the unencrypted data. While not shown, one or more additional tags may indicate how many times each given supported type of mathematical operation can be performed on data encrypted using cryptographic technique 400 (e.g., while still maintaining homomorphic properties).

Tag 403 indicates a processor utilization rating of 6. In an example, processor utilization ratings may range from 0-10, and generally indicate an amount of processing resources required by a cryptographic technique.

Tag 404 indicates a memory utilization rating of 4. In an example, memory utilization ratings may range from 0-10, and generally indicate an amount of memory resources required by a cryptographic technique.

Tag 406 indicates a network utilization rating of 4. In an example, network utilization ratings may range from 0-10, and generally indicate an amount of network resources required by a cryptographic technique.

Tag 408 indicates that an accelerator is not used by cryptographic technique 300.

Tags 401, 402, 403, 404, 406, and 408 are included as examples, and other types of tags may be included. Tags 401, 402, 403, 404, 406, and 408 generally allow a cryptographic agility system to identify which cryptographic techniques are best suited for a given cryptographic request or requests, such as related to a privacy-preserving data aggregation process, based on various characteristics, such as according to the results of a secure multi-endpoint cipher negotiation process as described herein.

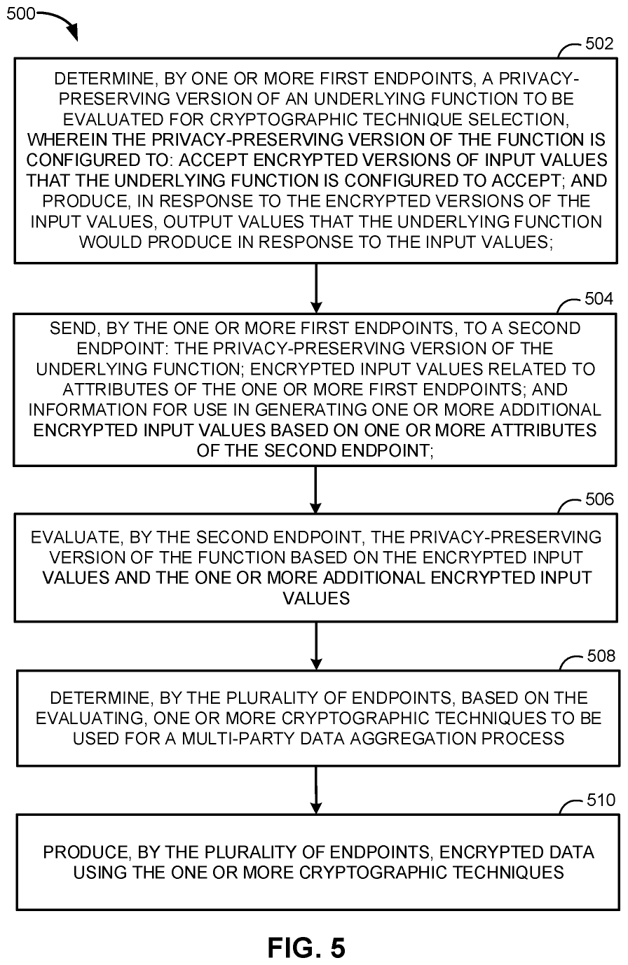

FIG. 5 depicts example operations 500 related to secure multi-endpoint cipher negotiation according to embodiments of the present disclosure. For example, operations 500 may be performed by one or more components of the cryptographic agility system described above with respect to FIGS. 1-4.

Operations 500 begin at step 502, with determining, by one or more first endpoints of a plurality of endpoints involved in a multi-party data aggregation process, a privacy-preserving version of an underlying function to be evaluated for cryptographic technique selection, wherein the privacy-preserving version of the function is configured to: accept encrypted versions of input values that the underlying function is configured to accept; and produce, in response to the encrypted versions of the input values, output values that the underlying function would produce in response to the input values.

Operations 500 continue at step 504, with sending, by the one or more first endpoints, to a second endpoint of the plurality of endpoints: the privacy-preserving version of the underlying function; encrypted input values related to attributes of the one or more first endpoints; and information for use in generating one or more additional encrypted input values based on one or more attributes of the second endpoint.

Operations 500 continue at step 506, with evaluating, by the second endpoint, the privacy-preserving version of the function based on the encrypted input values and the one or more additional encrypted input values.

Operations 500 continue at step 508, with determining, by the plurality of endpoints, based on the evaluating of the privacy-preserving version of the function, one or more cryptographic techniques to be used for the multi-party data aggregation process. In some embodiments, the one or more cryptographic techniques comprise one or more homomorphic encryption algorithms.

Operations 500 continue at step 510, with producing, by the plurality of endpoints, encrypted data using the one or more cryptographic techniques. Certain embodiments further comprise sending, by the plurality of endpoints, the encrypted data to one or more aggregator devices for privacy-preserving aggregation. In some embodiments, the one or more aggregator devices perform one or more aggregation operations based on the encrypted data without being granted access to unencrypted versions of the encrypted data. For example, a result of performing the one or more one or more aggregation operations based on the encrypted data may be sent to the plurality of endpoints, and the plurality of endpoints may obtain a decrypted version of the result based on one or more encryption keys used to produce the encrypted data.

In some embodiments, the one or more cryptographic techniques are selected based on the evaluating of the privacy-preserving version of the function and based on one or more types of mathematical operations to be performed by the one or more aggregator devices. In certain embodiments, the attributes of the one or more first endpoints and the one or more attributes of the second endpoint comprise computing resource constraints.

In certain embodiments, the computing resource constraints comprise a specific central processing unit (CPU) architecture within the one or more first endpoints or the second endpoint. In some embodiments, the computing resource constraints comprise a specific central processing unit (CPU) architecture within the one or more first endpoints or the second endpoint. In certain embodiments, the computing resource constraints comprise a maximum CPU core count and/or a maximum memory capacity. In some embodiments, the computing resource constraints comprise limitations in network bandwidth, network latency, or a communication medium.

In some embodiments, the attributes of the one or more first endpoints and the one or more attributes of the second endpoint comprise policy preferences. For example, the attributes of the one or more first endpoints and the one or more attributes of the second endpoint may comprise policy preferences. In certain embodiments, the policy preferences comprise one or more geographic considerations. In some embodiments, the policy preferences comprise one or more compliance considerations.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of multi-endpoint cipher negotiation, comprising:
determining, by one or more first endpoints of a plurality of endpoints involved in a multi-party data aggregation process, a privacy-preserving version of an underlying function to be evaluated for cryptographic technique selection, wherein the privacy-preserving version of the function is configured to:
accept encrypted versions of input values that the underlying function is configured to accept; and
produce, in response to the encrypted versions of the input values, output values that the underlying function would produce in response to the input values;
sending, by the one or more first endpoints, to a second endpoint of the plurality of endpoints:
the privacy-preserving version of the underlying function;
encrypted input values related to attributes of the one or more first endpoints; and
information for use in generating one or more additional encrypted input values based on one or more attributes of the second endpoint;
evaluating, by the second endpoint, the privacy-preserving version of the function based on the encrypted input values and the one or more additional encrypted input values;
determining, by the plurality of endpoints, based on the evaluating of the privacy-preserving version of the function, one or more cryptographic techniques to be used for the multi-party data aggregation process;
producing, by the plurality of endpoints, encrypted data using the one or more cryptographic techniques; and
sending, by the plurality of endpoints, the encrypted data to one or more aggregator devices for privacy-preserving aggregation.

2. The method of claim 1, wherein the one or more cryptographic techniques comprise one or more homomorphic encryption algorithms.

3. The method of claim 2, wherein the one or more aggregator devices perform one or more aggregation operations based on the encrypted data without being granted access to unencrypted versions of the encrypted data.

4. The method of claim 3, wherein a result of performing the one or more one or more aggregation operations based on the encrypted data is sent to the plurality of endpoints, and wherein the plurality of endpoints obtain a decrypted version of the result based on one or more encryption keys used to produce the encrypted data.

5. The method of claim 2, wherein the one or more cryptographic techniques are selected based on the evaluating of the privacy-preserving version of the function and based on one or more types of mathematical operations to be performed by the one or more aggregator devices.

6. The method of claim 1, wherein the attributes of the one or more first endpoints and the one or more attributes of the second endpoint comprise computing resource constraints.

7. The method of claim 6, wherein the computing resource constraints comprise a specific central processing unit (CPU) architecture within the one or more first endpoints or the second endpoint.

8. The method of claim 6, wherein the computing resource constraints comprise a maximum CPU core count and/or a maximum memory capacity.

9. The method of claim 6, wherein the computing resource constraints comprise limitations in network bandwidth, network latency, or a communication medium.

10. The method of claim 1, wherein the attributes of the one or more first endpoints and the one or more attributes of the second endpoint comprise policy preferences.

11. The method of claim 10, wherein the policy preferences comprise one or more geographic considerations.

12. The method of claim 10, wherein the policy preferences comprise one or more compliance considerations.

13. A system for multi-endpoint cipher negotiation, comprising:
at least one memory; and
at least one processor coupled to the at least one memory, the at least one processor and the at least one memory configured to:
determine, by one or more first endpoints of a plurality of endpoints involved in a multi-party data aggregation process, a privacy-preserving version of an underlying function to be evaluated for cryptographic technique selection, wherein the privacy-preserving version of the function is configured to:
accept encrypted versions of input values that the underlying function is configured to accept; and
produce, in response to the encrypted versions of the input values, output values that the underlying function would produce in response to the input values;
send, by the one or more first endpoints, to a second endpoint of the plurality of endpoints:
the privacy-preserving version of the underlying function;
encrypted input values related to attributes of the one or more first endpoints; and
information for use in generating one or more additional encrypted input values based on one or more attributes of the second endpoint;
evaluate, by the second endpoint, the privacy-preserving version of the function based on the encrypted input values and the one or more additional encrypted input values;
determine, by the plurality of endpoints, based on the evaluating of the privacy-preserving version of the function, one or more cryptographic techniques to be used for the multi-party data aggregation process;
produce, by the plurality of endpoints, encrypted data using the one or more cryptographic techniques; and
send, by the plurality of endpoints, the encrypted data to one or more aggregator devices for privacy-preserving aggregation.

14. The system of claim 13, wherein the one or more cryptographic techniques comprise one or more homomorphic encryption algorithms.

15. The system of claim 14, wherein the one or more aggregator devices perform one or more aggregation operations based on the encrypted data without being granted access to unencrypted versions of the encrypted data.

16. The system of claim 15, wherein a result of performing the one or more one or more aggregation operations based on the encrypted data is sent to the plurality of endpoints, and wherein the plurality of endpoints obtain a decrypted version of the result based on one or more encryption keys used to produce the encrypted data.

17. The system of claim 14, wherein the one or more cryptographic techniques are selected based on the evaluating of the privacy-preserving version of the function and based on one or more types of mathematical operations to be performed by the one or more aggregator devices.

18. The system of claim 13, wherein the attributes of the one or more first endpoints and the one or more attributes of the second endpoint comprise computing resource constraints.

19. The system of claim 18, wherein the computing resource constraints comprise a specific central processing unit (CPU) architecture within the one or more first endpoints or the second endpoint.

20. A non-transitory computer readable medium storing instructions that, when executed by one or more processors, cause the one or more processors to:
determine, by one or more first endpoints of a plurality of endpoints involved in a multi-party data aggregation process, a privacy-preserving version of an underlying function to be evaluated for cryptographic technique selection, wherein the privacy-preserving version of the function is configured to:
accept encrypted versions of input values that the underlying function is configured to accept; and
produce, in response to the encrypted versions of the input values, output values that the underlying function would produce in response to the input values;
send, by the one or more first endpoints, to a second endpoint of the plurality of endpoints:
the privacy-preserving version of the underlying function;
encrypted input values related to attributes of the one or more first endpoints; and
information for use in generating one or more additional encrypted input values based on one or more attributes of the second endpoint;
evaluate, by the second endpoint, the privacy-preserving version of the function based on the encrypted input values and the one or more additional encrypted input values;
determine, by the plurality of endpoints, based on the evaluating of the privacy-preserving version of the function, one or more cryptographic techniques to be used for the multi-party data aggregation process;
produce, by the plurality of endpoints, encrypted data using the one or more cryptographic techniques; and
send, by the plurality of endpoints, the encrypted data to one or more aggregator devices for privacy-preserving aggregation.
